(19) United States
(12) Patent Application Publication
(10) Pub. No.: US 2023/0335964 A1
(43) Pub. Date: Oct. 19, 2023

(54) SHORT PULSE LASER SYSTEM, AND METHOD FOR GENERATING LASER PULSES

(71) Applicant: Active Fiber Systems GmbH, Jena (DE)

(72) Inventors: Tino EIDAM, Jena (DE); Christian GAIDA, Jena (DE); Steffen HÄDRICH, Jena (DE); Fabian STUTZKI, Jena (DE)

(73) Assignee: Active Fiber Systems GmbH, Jena (DE)

(21) Appl. No.: 18/023,753

(22) PCT Filed: Aug. 5, 2021
(86) PCT No.: PCT/EP2021/071936

§ 371 Date: Jun. 7, 2023

(30) Foreign Application Priority Data
Aug. 31, 2020 (DE) 10 2020 122 731.0

(51) Int. Cl. H01S 3/00; G02F 1/35; G02F 1/365

(52) U.S. Cl. CPC H01S 3/0057; H01S 3/0092; G02F 1/3503; G02F 1/365; H01S 2301/08; G02F 2201/17

(57) ABSTRACT

The invention relates to an optical system comprising: a laser source which generates pulsed laser radiation consisting of a temporal sequence of laser pulses; and at least one pulse compression device which is located in the beam path and has a non-linear medium, wherein the laser pulses undergo non-linear spectral broadening during propagation through the medium, and a chirp is applied to the laser pulses. The aim of the invention is to provide an optical system which makes it possible to generate non-linearly compressed laser pulses with improved temporal pulse contrast or with improved pulse quality. According to the disclosed approach, a group delay dispersion which varies along the beam path and which compensates at least partially for the chirp is applied to the laser pulses by the pulse compression device.

### TECHNICAL FIELD

The present disclosure relates to an optical system having a laser source that generates pulsed laser radiation consisting of a temporal sequence of laser pulses; and at least one pulse compression device, which is located in the beam path and has a non-linear medium, wherein the laser pulses undergo non-linear spectral broadening during propagation through the medium, and a chirp is applied to the laser pulses.

The present disclosure also relates to a method for generating laser pulses, in which pulsed laser radiation consisting of a temporal sequence of laser pulses is generated and the generated laser pulses are spectrally broadened in a non-linear manner by applying a chirp.

### BACKGROUND

Laser systems for generating ultrashort laser pulses in the picosecond and femtosecond range have been receiving a lot of attention for years.

A variety of applications of such systems require a shorter pulse duration than is supported by the gain medium of the laser system. In addition, effects in the optical amplifier, such as saturation or gain narrowing, can lead to a decrease in the spectral bandwidth of the laser radiation, which results in an undesired increase in the pulse duration at the output of the laser system.

A known approach to shortening the pulse duration is to exploit non-linear effects to coherently generate new spectral components. The corresponding non-linear interactions can occur in the gain medium (non-linear amplification) or in separate components downstream of the optical amplifier in the beam path, in the form of a pulse compression device. The most frequently exploited non-linear interaction of laser radiation with a medium to increase the spectral bandwidth is self-phase modulation (SPM). SPM-induced spectral broadening can be achieved in media of various geometries, e.g. in optical waveguides such as light conducting fibers.

The SPM gives the laser pulses additional frequency components, so the laser radiation gains bandwidth. In order to be able to use the newly generated frequency components to shorten the pulse duration, the laser pulses must be as free as possible from chirps, i.e. free from different time delays of the different frequency components of the laser radiation. The pulse compression device therefore typically comprises dispersive elements downstream of the non-linear medium to compensate as far as possible for the chirp generated by the SPM and thereby temporally compress the laser pulses. The aim is to achieve a pulse duration as close as possible to the spectral bandwidth generated, i.e. bandwidth-limited laser pulses of minimum pulse duration. The compression factor achieved by the dispersive elements can be limited by various effects, such as ionization, achievable non-linearity, losses or a limited spectral bandwidth of the non-linear medium.

A known problem is that the pulse quality of the non-linearly compressed laser pulses is not perfect and a certain amount of the pulse energy is in secondary pulses or a temporal background of the laser radiation. This is due to the nature of SPM-induced spectral broadening, which is reflected in pronounced modulations in spectral intensity (see Agrawal, G. P., 2007, Nonlinear Fiber Optics, 4th edition, Amsterdam, Academic Press). Even a perfect elimination of the chirp leaves some of the pulse energy outside of the timed main pulse. It is known that for greater temporal compression factors, the temporal pulse contrast or pulse quality is typically reduced. A measure of the pulse quality is the proportion of the total pulse energy that falls within a certain time window around the maximum intensity of the pulse.

### SUMMARY

The present disclosure relates to an optical system of the type indicated at the outset, wherein a group delay dispersion that varies along the beam path and that compensates at least partially for the chirp is applied to the laser pulses by the pulse compression device.

The optical system makes it possible to generate non-linearly compressed laser pulses with improved temporal pulse contrast or with improved pulse quality.

The present disclosure also relates to a method for generating laser pulses, in which pulsed laser radiation consisting of a temporal sequence of laser pulses is generated and the generated laser pulses are spectrally broadened in a non-linear manner by applying a chirp, wherein a group delay dispersion variable along the beam path is applied on the laser pulses, which group delay dispersion effects an at least partial compensation of the chirp.

The basic idea is a pulse compression device in which the spectral broadening and the compensation of the chirp takes place distributed over as many individual steps as possible (in the limit case infinitesimally small steps), which corresponds to a (quasi-) adiabatic pulse compression. Ideally, the compression factor, i.e. the factor of the temporal pulse shortening, is kept as small as possible per step, which reduces the spectral modulations in the SPM broadened spectrum of the laser pulses. Preferably, the compression factor per step should be less than four, preferably less than three, more preferably less than two. This reduces the energy content in secondary pulses and effectively increases the peak pulse power. After each step of the SPM-induced spectral broadening, the laser pulse is compressed accordingly by applying group delay dispersion (GDD). In the simplest case, the strength of the non-linear interaction remains unchanged in the subsequent steps. However, due to the ever decreasing pulse duration and the resulting increasing pulse peak power, the spectral broadening increases and thus the applied chirp per step also varies. Accordingly, the group delay dispersion must vary from step to step, i.e. along the beam path, in order to compensate as far as possible for the chirp applied in each step.

### BRIEF DESCRIPTION OF THE DRAWINGS

Exemplary embodiments are explained in more detail on the basis of the drawings. In the figures:

FIG. 1 shows a schematic representation of an optical system as a block diagram;

FIG. 2 shows a schematic representation of a pulse compression device implemented on the basis of light-conducting fibers;

FIG. 3 shows a schematic representation of a pulse compression device implemented on the basis of a multipass cell;

FIG. 4 shows diagrams of the shortening of the pulse duration, of the spectrum and of the temporal pulse progression of non-linearly compressed laser pulses;

FIG. 5 shows a diagram illustrating the non-linear pulse compression divided into several steps;

FIG. 6 shows a schematic representation of segmented mirrors of the multipass cells according to FIG. 3.

### DETAILED DESCRIPTION OF EMBODIMENTS

In possible embodiments, the group delay dispersion varies continuously or in stages along the beam path. In fact, non-linear compression can be gradual, whereby the non-linear medium is divided into two or more sections separate from one another, which are successively passed through by the laser radiation, wherein each of the sections of the non-linear medium are followed in the beam path by a dispersive optical element associated with that section, wherein the optical elements differ from one another with respect to the group delay dispersion. In this design, sections of the non-linear medium alternate with dispersive elements assigned thereto. Each section of the non-linear medium with its associated dispersive element is to be assigned to a step of the non-linear compression. The dispersive element is designed with respect to the group delay dispersion such that the chirp generated in the associated step is largely compensated and thus overall spectral modulations during the non-linear compression are reduced.

SPM is an intensity-dependent effect, which means that in interaction areas (of the non-linear medium with the laser radiation) of higher intensity, a stronger spectral broadening takes place than in areas of lower intensity. Consequently, a laser beam with a typical Gaussian beam profile experiences a spatially inhomogeneous spectral broadening during propagation through the non-linear medium, e.g. a glass plate. The spectral broadening is more pronounced near the beam axis than in the peripheral areas further away from the beam axis. However, many applications require a spectral bandwidth of the laser pulses that is homogeneous across the beam profile. A known approach to spatially homogeneous spectral broadening of pulsed laser radiation (see Nenad Milosevic, Gabriel Tempea, and Thomas Brabec, “Optical pulse compression: bulk media versus hollow waveguides,” Opt. Lett. 25, 672-67 4, 2000) exploits the fact that spectral broadening is spatially homogeneous in a medium that is located in an imaging mirror array, a multipass cell, which is designed as a stable resonator. Accordingly, the non-linear medium in the optical system according to the present disclosure can advantageously be located in a multipass cell through which the laser radiation passes several times. A multipass cell comprises an arrangement of two or more (partially focusing) mirrors that redirect a laser beam coupled into the multipass cell at each reflection point such that the beam propagation is limited to a predefined volume along a controlled propagation path in the multipass cell until the laser beam leaves the multipass cell after a plurality of reflections and thus passes through the volume of the multipass cell. Known designs of multipass cells are called e.g. White cells or Herriott cells. The use of a multipass cell for spatially homogeneous spectral broadening requires that the mirrors of the multipass cell are shaped and arranged in such a way that the multipass cell forms a stable optical resonator that is characterized in that Gaussian beams exist as transverse intrinsic solutions of the resonator, which experience the desired spatial homogenization of the spectral broadening in the same way as transverse intrinsic solutions in non-linear waveguides.

A dielectric material (e.g. a glass plate) or a gas (e.g. a noble gas) can be used as a non-linear medium that is located in the multipass cell and is accordingly passed through several times by the laser radiation. It is also conceivable to arrange several non-linear elements in the multipass cell; a glass plate with varying thickness can be used, or areas with different gas pressure can be provided in the multipass cell.

The destruction threshold of the mirrors used to realize the multipass cell limits the compressible pulse energy or the peak pulse power that can be coupled into the cell. The destruction threshold depends on the intensity of the laser radiation. In principle, the intensity on the mirror surfaces can be reduced by increasing the distances between the mirrors. Furthermore, it is possible to work close to a concentric mirror configuration, which results in the largest beam radii on the mirror surfaces among all symmetrical arrangements. However, this configuration leads to small focuses of the laser radiation, which in turn must be taken into account in the design with regard to the non-linear interaction in the medium. On the one hand, destruction of the medium or excessive ionization must also be avoided here and, on the other hand, the accumulated non-linear phase per revolution must not exceed a certain limit value in order to keep the non-linear pulse compression per step sufficiently low within the meaning of the present disclosure.

The stepwise compensation of the chirp can be achieved in that the mirrors of the multipass cells are designed to be dispersive (e.g. as dielectric mirrors). At least one of the mirrors can thus be suitably segmented, wherein the laser radiation is successively reflected at different segments of the mirror when passing through the multipass cell several times. At least two of the segments of the mirror differ from one another with regard to the group delay dispersion applied, such that with each compression step, i.e. with each pass of the laser radiation through the non-linear media located in the multipass cell, the appropriate group delay dispersion is applied to the laser radiation during the subsequent reflection at the corresponding mirror, in order to largely compensate for the chirp generated in each case and thereby keep the spectral modulations low.

The multipass cell can be designed with the associated (segmented) mirrors in such a way that the non-linear compression takes place with a subdivision into a comparatively large number of steps. Accordingly, the laser radiation passes through the multipass cell, i.e. the focus of the multipass cell, at least three times, preferably at least five times, particularly preferably at least ten times or even more than twenty times.

Because the non-linear medium in the multipass cell is passed through several times by the laser radiation, the laser radiation experiences an essentially constant non-linear susceptibility at each step along the entire beam path. However, a sequence of multipass cells of the type described with different susceptibilities along the beam path is also conceivable.

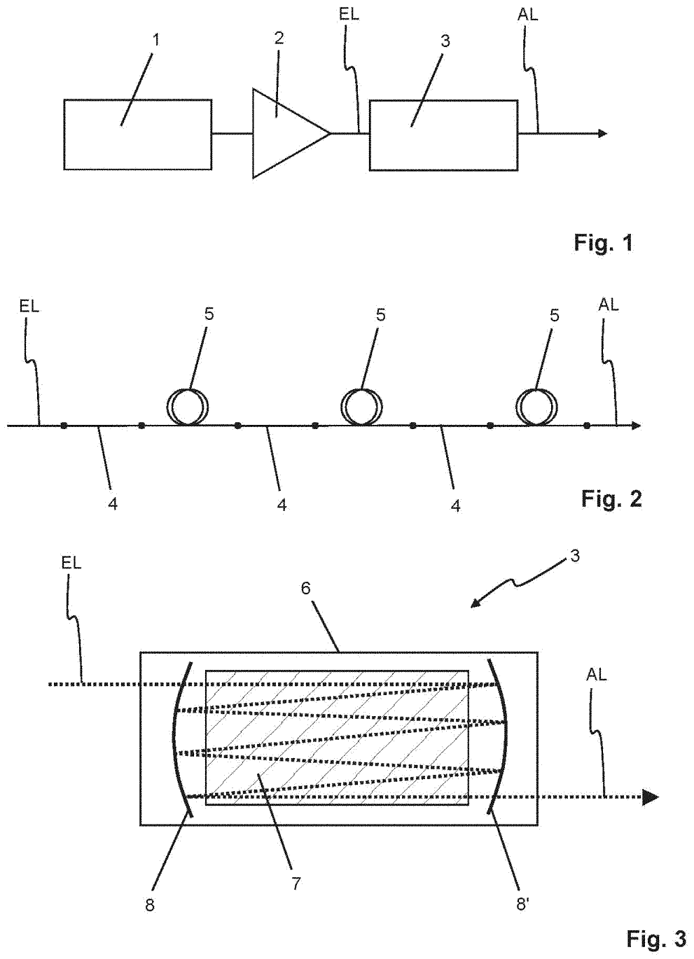

In the exemplary embodiment of FIG. 1, an input laser beam EL is generated from pulsed laser radiation by means of a laser source 1 (e.g. comprising a mode-coupled fiber oscillator) with a downstream optical amplifier 2. The input laser beam EL is supplied to a pulse compression device 3. The pulse compression device 3 contains a non-linear medium (not shown in FIG. 1), which effects a non-linear spectral broadening of the laser pulses by means of self-phase modulation. The resulting chirp is compensated by dispersive elements (not shown in FIG. 1) of the pulse compression device 3, such that the laser pulses in the output laser beam AL leaving the pulse compression device 3 are (almost) bandwidth-limited.

According to the embodiment, the spectral broadening and the compensation of the chirp in the pulse compression device are distributed over a number of individual steps in order to achieve a (quasi-)adiabatic pulse compression. Ideally, the compression factor, i.e. the factor of the temporal pulse shortening, is kept as small as possible per step, which reduces the spectral modulations in the SPM broadened spectrum of the laser pulses.

In the exemplary embodiment of FIG. 2, the pulse compression device 3 comprises a plurality of sections of non-linear fibers 4 (e.g. gas-filled hollow core fibers or conventional step index fibers) for spectral broadening of the laser pulses by means of SPM, each followed by a suitably dispersive fiber section 5, 5′, 5″, which applies a suitable group delay dispersion on the laser pulses propagating through the fiber arrangement, in such a way that the chirp applied to the laser pulses in the associated non-linear fiber section 4 is compensated for as completely as possible. The dispersive fiber sections 5, 5′, 5″ differ with regard to the applied group delay dispersion, e.g. by suitable design of the lengths of the fiber sections 5, 5′, 5″. In the exemplary embodiment of FIG. 2, the non-linear pulse compression is thus split into three individual steps. A larger number is conceivable, although practicality reaches its limits with a very large number of steps (e.g. 20 or more).

In the exemplary embodiment of FIG. 3, the pulse compression device 3 is achieved by a non-linear multipass cell 6, which enables a spatially homogeneous spectral broadening by means of SPM. Accordingly, the spectral dispersion in the imaging mirror arrangement of the multipass cell 6 is homogenized as long as it is in the range of a stable mirror configuration, i.e. a Gaussian mode can be found as a transversal intrinsic solution. A dielectric material (e.g. a glass plate) or a gas (e.g. a noble gas) can be used as the non-linear medium 7 located in the multipass cell 6. On the one hand, the multipass cell 6 allows almost loss-free spectral broadening and, on the other hand, the non-linear interaction (in the focus) and dispersion can be adjusted largely separately from one another. Assuming that the dispersion of the non-linear medium 7 is negligible, the dispersion of one or more mirrors 8, 8′, between which the laser radiation is reflected back and forth by the multipass cell 7, can be used to achieve a pulse compression by compensation of the chirp in steps according to the embodiment (i.e. after each non-linear interaction of the laser radiation with the medium 7 in the focus passage). The dispersion properties of the mirrors 8, 8′, on which the beams of the individual passes are spatially separated from one another, are designed in such a way that a group delay dispersion, which varies along the beam path, i.e. from reflection to reflection, is applied to the laser pulses in order to compensate for the chirp. Advantageously, the mirrors can be segmented here (see FIG. 6), wherein the laser radiation is successively reflected at different segments (numbered from 1 to 20 in FIG. 6) of the mirror 8, 8′ when passing through the multipass cell 6 several times. The segments of the mirrors 8, 8′ differ from one another with regard to the group delay dispersion applied during the reflection process in order to compensate the chirp to a large extent for each compression step.

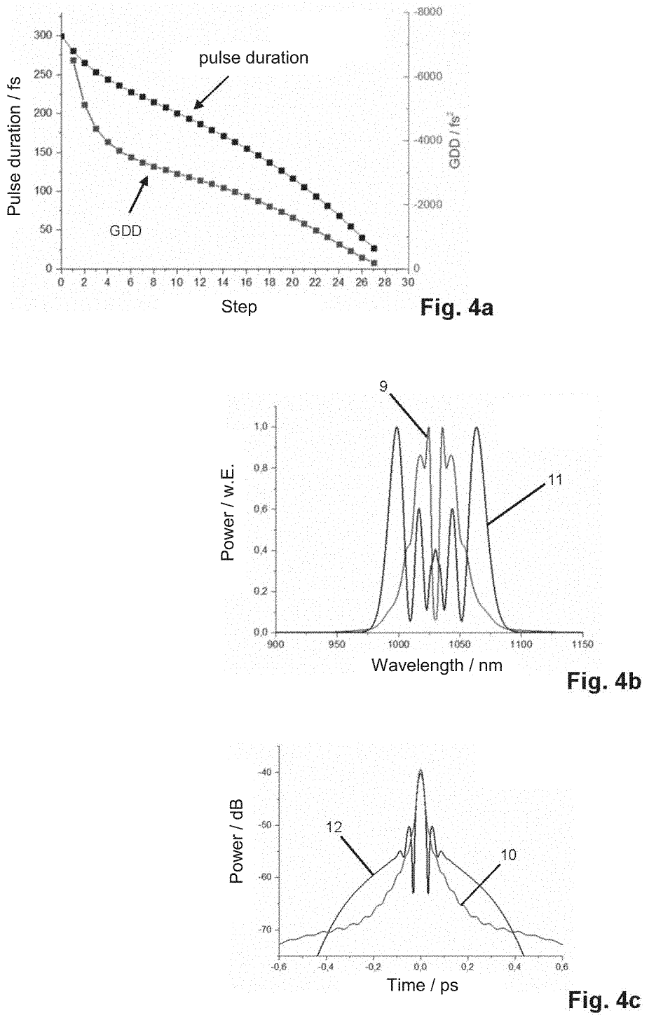

The principle of the present disclosure is explained below using the diagrams in FIG. 4. The output point is a laser pulse (Gaussian pulse) generated (and amplified) by means of laser source 1 with a 300 fs pulse duration and 1 mJ pulse energy. The non-linear medium irradiated several times has a non-linear parameter of y=2.5·10−7 (W·m)⁻¹ per compression step that acts on a distance (e.g. irradiated thickness of the medium) of 250 μm. After each step of the SPM- spectral broadening, the laser pulse is compressed by applying group delay dispersion. The strength of the non-linear interaction remains unchanged in the subsequent steps. However, due to the decreasing pulse duration and the resulting increasing pulse peak power, the spectral broadening per step increases. For the sake of simplicity, losses and non-linear effects of higher order are neglected and a consideration of the pulse compression under consideration of higher phase terms (e.g. dispersion of third order) is also not carried out. The diagrams of FIG. 4 show the (simulation) results) of the pulse compression performed in this way in stages. The diagram of FIG. 4a shows the pulse duration achieved after each step and the group delay dispersion required for this in each step. FIGS. 4b and 4c show the result of the 27-stage pulse compression in the spectral and time range (curves 9, 10) compared to the simulated case of a conventional, one-stage pulse compression (curves 11, 12). The spectral width has increased to 42.7 nm, while the 300 fs input pulse is compressed to 28.5 fs. The decisive factor is the pulse energy content in a +/−50 fs window around the pulse maximum, which is 90% of the total pulse energy and thus significantly higher than in the case of the single-stage non-linear compression also shown, where only 73% of the total pulse energy is contained in the same time window. The example of FIG. 4 is only intended to illustrate the approach and does not represent an optimized solution. A further increase in pulse contrast is possible by adjusting the number of steps, the strength of the non-linearity per step and the chirp compensation per step.

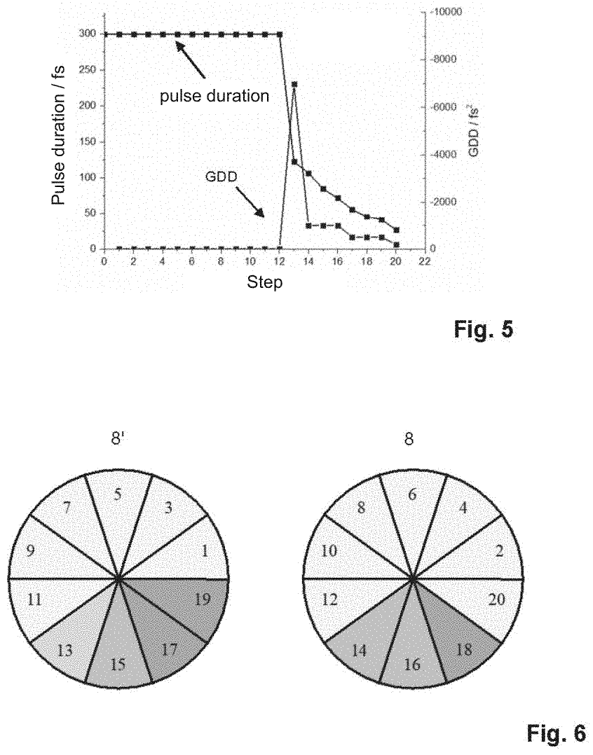

FIG. 5 illustrates the pulse duration achieved for the mirror design of FIG. 6 after each step and the group delay dispersion required for each step. The output point is again a 300 fs laser pulse with 1 mJ pulse energy. The non-linear medium 7 irradiated several times has a non-linear parameter of y=2.5·10⁻⁷(Wm)⁻¹ per broadening step that acts on a length of 250 μm. Accordingly, the laser pulses each propagate 13 times through the non-linear medium 7 and experience a spectral broadening in the process without any compensation of the chirp generated in the process. This is followed by a mirror reflection with an imposed group delay of −7000 fs², which shortens the laser pulse to approx. 120 fs. The following three steps consist of non-linear spectral broadening and each −1000 fs² group delay dispersion, followed by three steps of non-linear spectral broadening and each −500 fs² group delay dispersion and finally a pass through the non-linear medium 7 and finally a single −200 fs² group delay dispersion. The original spectral bandwidth of the laser pulses of 5.234 nm is thereby increased to 45.8 nm bandwidth (FWHM). The compressed pulse duration at the end is 28.6 fs, and the energy fraction in the +/−50 fs window around the pulse maximum is 89%, which is very close to the value of the finely graduated non-linear compression shown in FIG. 4 (there with 27 steps), with considerably simplified realization by means of the segmented mirrors 8, 8′ shown in FIG. 6.

Each of the two mirrors 8, 8′ in FIG. 6 consists of ten segments, wherein the first twelve segments overlapped by the beam path (numbered 1-12) have a vanishing group delay dispersion, segment 13 on mirror 8′ has a group delay dispersion of −7000 fs², segments 14 and 16 on mirror 8 as well as segment 15 on mirror 8′ have a group delay dispersion of −1000 fs², segment 18 on mirror 8 and segments 17 and 19 on mirror 8′ have a group delay dispersion of −500 fs² and segment 20 on mirror 8 again has a vanishing group delay dispersion (the last compression step in this case occurs outside the multipass cell).

It should also be mentioned that FIG. 6 shows an example for illustration purposes and not an optimized configuration. It should also be noted that the function according to the present disclosure does not necessarily have to be realized in a multi-pass cell. Twenty individual, at least partially curved mirrors with corresponding characteristics with regard to dispersion or applying the dispersion not by the mirrors but by additional elements, for example, provide an identical result. Likewise, it is not mandatory to use only one non-linear element.

In the approach to improve the pulse contrast or the pulse quality of non-linearly compressed laser pulses, it should be noted, in particular with regard to the specific exemplary embodiment with the multipass cell 6, that the increasing pulse peak power with multiple passes through the non-linear medium should not lead to undesirable effects in the multipass cell, such as the destruction of the mirrors, disturbing ionization in the focus between the mirrors or an excessively strong non-linear interaction per focus pass.

This would manifest itself in a deterioration of the spatial-spectral homogeneity of the laser beam in the output beam AL. These limiting effects must be taken into account when designing the multipass cell 6. One possible solution is a sequence of multipass cells of the type described with different non-linearity and/or different mirror configuration (e.g. with regard to radii of curvature and spacing).

It should also be noted that even with lossy methods of spectral broadening (e.g. in a capillary or in a multi-pass cell with metallic mirrors), the approach of the invention can be advantageous over conventional single-step spectral broadening due to the maintenance of strong non-linear interactions.

It is also conceivable, as already mentioned, to use adiabatic non-linear pulse compression in a series arrangement of two or more multipass cells of the type described, each with adapted mirrors and non-linear media, in order to produce a pulse duration in the range of only a few optical cycles with simultaneously high temporal quality.

1. Optical system having a laser source that generates pulsed laser radiation consisting of a temporal sequence of laser pulses, and at least one pulse compression device which is located in the beam path and comprises a non-linear medium, wherein the laser pulses undergo non-linear spectral broadening during propagation through the medium, and a chirp is applied to the laser pulses,
wherein a group delay dispersion that varies along the beam path and that compensates at least partially for the chirp is applied to the laser pulses by the pulse compression device.

2. Optical system according to claim 1, wherein the applied group delay dispersion varies continuously or in stages along the beam path.

3. Optical system according to claim 1, wherein the non-linear medium is divided into two or more sections separate from one another, which are successively passed through by the laser radiation, wherein at least some or each of the sections of the non-linear medium are followed in the beam path by a dispersive optical element associated with that section, wherein at least two of all of the optical elements differ from one another with respect to the group delay dispersion applied thereby.

4. Optical system according to claim 3, wherein the compression factor, i.e. the factor of the temporal pulse shortening of the laser pulses per section with respectively assigned dispersive optical element is smaller than four, preferably smaller than three, particularly preferably smaller than two.

5. Optical system according to claim 1, wherein the non-linear medium is located in a multipass cell that the laser radiation passes through several times.

6. Optical system according to claim 5, wherein the multipass cell has at least two mirrors between which the laser radiation is reflected back and forth.

7. Optical system according to claim 6, wherein the shape and arrangement of the mirrors is selected such that the multipass cell forms a stable optical resonator.

8. Optical system according to claim 6, wherein the mirrors are spherical and in a concentric arrangement, wherein the non-linear medium is located in the center of the arrangement.

9. Optical system according to claim 6, wherein the mirrors are dispersive.

10. Optical system according to claim 9, wherein the mirrors differ from one another with regard to the applied group delay dispersion.

11. Optical system according to claim 6, wherein at least one of the mirrors is segmented, wherein the laser radiation is successively reflected at different segments of the mirror when passing through the multipass cell several times.

12. Optical system according to claim 11, wherein at least two of the segments of the mirror differ from one another with regard to the applied group delay dispersion.

13. Optical system according to claim 5, wherein the laser radiation passes through the multipass cell at least three times, preferably at least five times, particularly preferably at least ten times.

14. Optical system according to claim 5, wherein the compression factor, i.e. the factor of the temporal pulse shortening of the laser pulses per pass is less than four, preferably less than three, particularly preferably less than two.

15. Optical system according to claim 1, wherein the non-linear susceptibility of the medium is substantially constant along the beam path.

16. Method for generating laser pulses, in which pulsed laser radiation consisting of a temporal sequence of laser pulses is generated and the generated laser pulses are spectrally broadened in a non-linear manner by applying a chirp,
wherein
a group delay dispersion that varies along the beam path and that compensates at least partially for the chirp is applied to the laser pulses.

17. Method according to claim 16, wherein the applied group delay dispersion varies continuously or stepwise along the beam path.

18. Method according to claim 16, wherein the non-linear spectral broadening and the corresponding compensation of the chirp are performed in two or more successive individual steps, wherein the compression factor, i.e. the factor of the temporal pulse shortening of the laser pulses per individual step is less than four, preferably less than three, particularly preferably less than two.
